(19) United States
(12) Patent Application Publication
(10) Pub. No.: US 2014/0169289 A1
(43) Pub. Date: Jun. 19, 2014

(54) APPARATUS AND METHOD FOR ACCELERATING CONNECTION ESTABLISHMENT IN A MOBILE COMMUNICATION

(71) Applicant: MEDIATEK INC., HSIN-CHU (TW)

(72) Inventors: Weirong CHU, New Taipei City (TW); Yuan-Chieh LIN, Taichung City (TW); Po-Ying CHUANG, Taipei City (TW); Chi-Hsien CHEN, Taipei City (TW)

(73) Assignee: MEDIATEK INC., HSIN-CHU (TW)

(21) Appl. No.: 14/090,462

(22) Filed: Nov. 26, 2013

Related U.S. Application Data
(60) Provisional application No. 61/739,194, filed on Dec. 19, 2012.

(51) Int. Cl. H04W 76/02

(52) U.S. Cl. CPC H04W 76/022
USPC 370/329

(57) ABSTRACT

The method and apparatus for accelerating connection establishment in a mobile communications system are provided. The method includes transmitting, by a user equipment, an Activate PDP Context Request to a network; determining whether the user equipment can be confirmed that the network received the Activate PDP Context Request by an lower layer; shortening a default timer value and retransmitting the Activate PDP Context Request to the network after the shortened default value if the lower layer does not confirm that the network received the Activate PDP Context Request; and preserving the default timer value if the lower layer confirms that the network received the Activate PDP Context Request.

### CROSS REFERENCE TO RELATED APPLICATIONS

This application claims priority of U.S. Provisional Patent Application No. 61/739,194, filed on Dec. 19, 2012, the entirety of which is incorporated by reference herein.

### BACKGROUND OF THE INVENTION

1. Field of the Invention

The invention generally relates to the PDP (Packet Data Protocol) context activation procedure, and more particularly, to reducing the default timer value of the PDP context activation procedure in mobile communications devices.

2. Description of the Related Art

Wireless communications systems are widely deployed to provide various telecommunications services such as telephony, video, data, messaging, and broadcast. Typical wireless communications systems may employ multiple-access technologies capable of supporting communications with multiple users by sharing available system resources (e.g., bandwidth, transmitting power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

A packet data protocol (PDP) context may be established to carry traffic flows over the communications system. A PDP context typically includes a radio access bearer provided between the user equipment, the radio network and the Serving GPRS Support Node (SGSN), and switched packet data channels provided between the SGSN and the Gateway GPRS Support Node (GGSN). A session between the user equipment and other party would then be carried on the established PDP context. A PDP context can carry more than one traffic flow, but all traffic flows within one particular PDP context are treated the same way as regards their transmission across the network. This requirement regarding the similar treatment is based on PDP context-treatment attributes associated with the traffic flows. These attributes may comprise, for example, quality of service and/or charging attributes. The PDP context specifies different data transmission parameters, such as the PDP type (e.g. X.25 or IP), PDP address (e.g. X.121 address), Quality of Service (QoS), Transaction Identifier (TI), and Network Service Access Point Identifier (NSAPI).

For example, in GPRS networks, the user equipment may optionally indicate, in a message requesting activation of a PDP context in the network, an access point name (APN) for selection of a reference point to a certain external network. A SGSN may authenticate the user equipment and send a PDP context-creation request to a selected GGSN e.g. according to the access point name given by the user equipment, or to default GGSN known by the SGSN.

When the user equipment transmits “Activate PDP Context Request” to a service network and cannot get a response from the network, a default timer value of a timer may be activated. However, the waiting time of the current timer, such as T3380, is too long. For example, T3380 is a 30-second timer in a PDP context activation procedure. If the user equipment transmits “Activate PDP Context Request” to the service network through a Session Management (SM) layer and gets no response from the service network, the user equipment may need to wait 30 seconds before retransmitting the next “Activate PDP Context Request” to the service network. The waiting time associated with the T3380 is too long, causing some tests to fails and users to feel bad.

### BRIEF SUMMARY OF THE INVENTION

Apparatus and methods for accelerating connection establishment in a mobile communications system are provided to overcome the above-mentioned problems.

An embodiment of the invention provides a method for accelerating connection establishment in a mobile communications system, comprising: transmitting, by a user equipment, an Activate PDP Context Request to a network; determining whether the user equipment can be confirmed that the network received the Activate PDP Context Request by an lower layer (ex. RLC, LLC . . . ); shortening a default timer value and retransmitting the Activate PDP Context Request to the network after the shortened default value if the lower layer does not confirm that the network received the Activate PDP Context Request; and preserving the default timer value if the lower layer confirms that the network received the Activate PDP Context Request. In this embodiment, the method further comprises that determining whether the user equipment received a response from an RRC layer after determining whether it can be confirmed that the network received the Activate PDP Context Request from the lower layer, wherein the response of the RRC layer indicates that the network cannot respond to the Activate PDP Context Request.

An embodiment of the invention provides an apparatus for accelerating connection establishment in a mobile communications system, operating as a user equipment (UE), comprising: a transceiver, configured to transmit an Activate PDP Context Request to a network; and a processing unit, configured to determine whether it can be confirmed that the network received the Activate PDP Context Request by an lower layer, wherein if the lower layer does not confirm that the network received the Activate PDP Context Request, a default timer value is shortened by the processing unit and the Activate PDP Context Request is retransmitted to the network by the transceiver after the shortened default value; and wherein if the lower layer confirms that the network received the Activate PDP Context Request, the default timer value is preserved. In this embodiment, the processing unit further determines whether the user equipment received a response from an RRC layer after determining whether it can be confirmed that the network received the Activate PDP Context Request from the lower layer, wherein the response of the RRC layer indicates that the network cannot respond to the Activate PDP Context Request.

Other aspects and features of the invention will become apparent to those with ordinary skill in the art upon review of the following descriptions of specific embodiments of apparatus and methods for accelerating connection establishment.

### BRIEF DESCRIPTION OF THE DRAWINGS

The invention will become more fully understood by referring to the following detailed description with reference to the accompanying drawings, wherein:

FIG. 1 is a block diagram of a mobile communications system 100 according to an embodiment of the invention;

FIG. 2 is a message sequence chart illustrating the PDP context activation procedure in a mobile communications system according to an embodiment of the invention;

FIG. 3 is a message sequence chart illustrating the PDP context activation procedure in a mobile communications system according to another embodiment of the invention;

FIG. 4 is a message sequence chart illustrating the PDP context activation procedure in a mobile communications system according to still another embodiment of the invention;

FIG. 5 is a message sequence chart illustrating one solution for the side effect in a mobile communications system according to an embodiment of the invention;

FIG. 6 is a message sequence chart illustrating another solution for the side effect in a mobile communications system according to an embodiment of the invention;

FIG. 7 is a message sequence chart illustrating still another solution for the side effect in a mobile communications system according to an embodiment of the invention; and

FIG. 8 is a flow chart illustrating the method for accelerating connection establishment in a mobile communications system according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

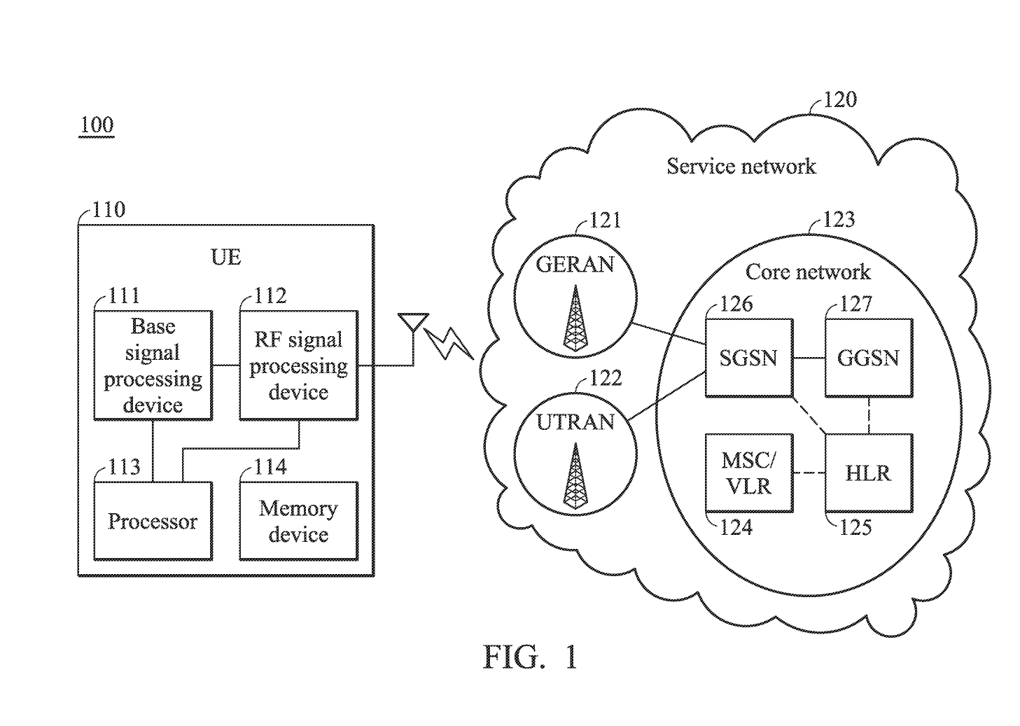

FIG. 1 is a block diagram of a mobile communications system 100 according to an embodiment of the invention. The system 100 comprises the User Equipment (UE) 110, and service network 120. The UE 110 may be a mobile communications device, such as a cellular phone, a smartphone modem processor, a data card, a laptop stick, a mobile hotspot, an USB modem, a tablet, or others.

The UE 110 may comprise at least a baseband signal processing device 111, a radio frequency (RF) signal processing device 112, a processor 113, a memory device 114, and an antenna module comprising at least one antenna. Note that, in order to clarify the concept of the invention, FIG. 1 presents a simplified block diagram in which only the elements relevant to the invention are shown. However, the invention should not be limited to what is shown in FIG. 1.

The RF signal processing device 112 may receive RF signals via the antenna and process the received RF signals to convert the received RF signals to baseband signals to be processed by the baseband signal processing device 111, or receive baseband signals from the baseband signal processing device 111 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, or others.

The baseband signal processing device 111 may further process the baseband signals to obtain information or data transmitted by the peer communications apparatus. The baseband signal processing device 111 may also comprise a plurality of hardware elements to perform baseband signal processing. The baseband signal processing may comprise analog-to-digital conversion (ADC)/digital-to-analog conversion (DAC), gain adjustment, modulation/demodulation, encoding/decoding, and so on.

The processor 113 may control the operations of the baseband signal processing device 111 and the RF signal processing device 112. According to an embodiment of the invention, the processor 113 may also be arranged to execute the program codes of the software module(s) of the corresponding baseband signal processing device 111 and/or the RF signal processing device 112. The program codes accompanied with specific data in a data structure may also be referred to as a processor logic unit or a stack instance when being executed. Therefore, the processor 113 may be regarded as being comprised of a plurality of processor logic units, each for executing one or more specific functions or tasks of the corresponding software module(s). In addition, the processing unit 113 further comprises a detection module (not present in FIG. 1), wherein the detection module is configured to determine whether system information corresponding to candidate cells is provided in the redirection information. The memory device 114 may store the software and firmware program codes, system data, user data, etc. of the UE 110. The memory device 114 may be a volatile memory, e.g. a Random Access Memory (RAM), or a non-volatile memory, e.g. a flash memory, Read-Only Memory (ROM), or hard disk, or any combination thereof In an embodiment of the invention, the memory device 114 stores the system information which the UE 110 collected previously.

According to an embodiment of the invention, the RF signal processing device 112 and the baseband signal processing device 111 may be collectively regarded as a radio module capable of communicating with a wireless network to provide wireless communications services in compliance with a predetermined Radio Access Technology (RAT). Note that, in some embodiments of the invention, the UE 110 may further be extended to comprise more than one antenna and/or more than one radio module, and the invention should not be limited to what is shown in FIG. 1.

In addition, in some embodiments of the invention, the processor 113 may be configured inside of the baseband signal processing device 111, or the UE 110 may comprise another processor configured inside of the baseband signal processing device 111. Thus the invention should not be limited to the architecture as shown in FIG. 1.

The service network 120 may comprise a GSM EDGE Radio Access Network (GERAN) 121, a Universal Terrestrial Radio Access Network (UTRAN) 122, a core network 123. The GERAN 121 and UTRAN 122 may be in communications with the core network 123, wherein the GERAN 121 and UTRAN 122 allow connectivity between the UE 110 and the core network 123 by providing the functionality of wireless transmission and reception to and from the UE 110 for the core network 123, and the core network 123 signals the required operation to the GERAN 121 and UTRAN 122 for providing wireless services to the UE 110. The GERAN 121 and UTRAN 122 may contain one or more base stations (or called NodeBs or eNodeBs) and Radio Network Controllers (RNCs). Specifically, the core network 123 comprises a Mobile Switching Center/Visitor Location Register (MSC/VLR) 124 and a Home Location Register (HLR) 125 belonging to a circuit-switched (CS) service domain, and a Serving GPRS Support Node (SGSN) 126 and a Gateway GPRS Support Node (GGSN) 127 belonging to a packet-switched (PS) service domain, wherein the SGSN 126 is the key control node for packet routing and transfer, mobility management (e.g., attach/detach and location management), session management, logical link management, and authentication and charging functions, etc., and the GGSN 127 is responsible for Packet Data Protocol (PDP) address assignments and inter-working with external networks. The MSC/VLR 124 is responsible for connection setup for the circuit-switched services and for routing such services to the correct addresses. The HLR 125 is a central database storing user-related and subscription-related information, and the invention is not limited thereto.

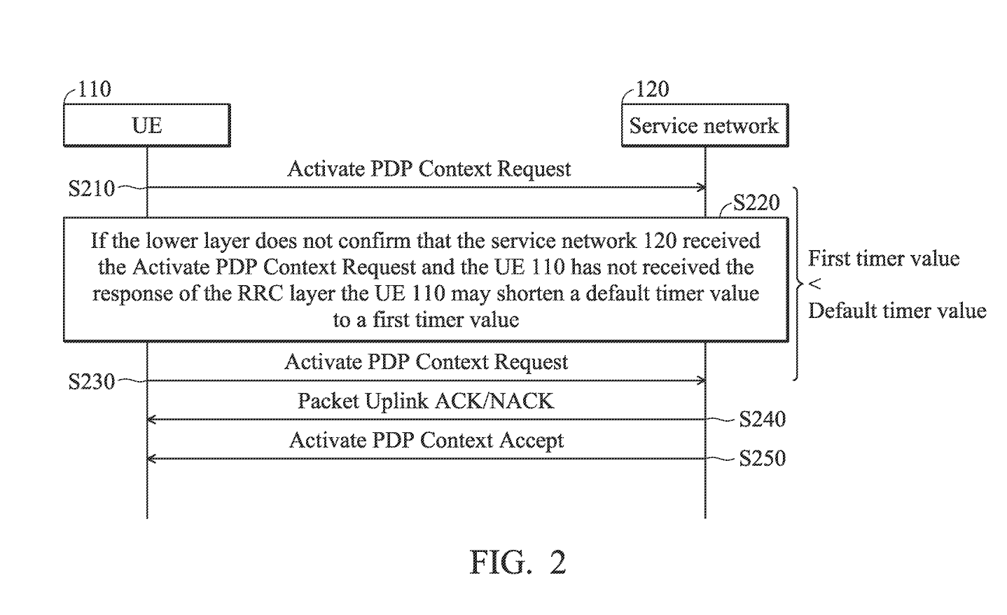

FIG. 2 is a message sequence chart illustrating the PDP context activation procedure in a mobile communications system according to an embodiment of the invention. Firstly, the UE 110 transmits an Activate PDP Context Request to the service network 120 in the Session Management (SM) layer (step S210). Then, if the lower layer (such as Radio Link Control (RLC) layer or Logical Link Control (LLC) layer) does not confirm that the service network 120 received the Activate PDP Context Request and the UE 110 has not received the response of the Radio Resource Control (RRC) layer, the UE 110 may shorten a default timer value to a first timer value, wherein the default timer value is used to determine whether UE 110 needs to retransmit the Activate PDP Context Request to the service network again (step S220). Then, the UE 110 may retransmit the Activate PDP Context Request again after the first timer value (step S230). Specifically, lower layer cannot confirm whether the service network 120 has received the Activate PDP Context Request from the UE 110 successfully, because the lower layer doesn't receive the Packet Uplink ACK/NACK from the service network 120. In addition, the response of the RRC layer indicates that the service network 120 cannot respond to the Activate PDP Context Request from the UE 110. That is to say, the RRC connection between the UE 110 and the service network 120 has been released by the service network 120. Therefore, the service network 120 cannot respond to the Activate PDP Context Request. When the service network 120 transmits the Packet Uplink ACK/NACK to the UE 110 through the lower layer (step S240) and then the service network 120 transmits the Activate PDP Context Accept to the UE 110 (step S250), the PDP Context has been activated. In this embodiment, the first timer is activated according to the information of the lower layer.

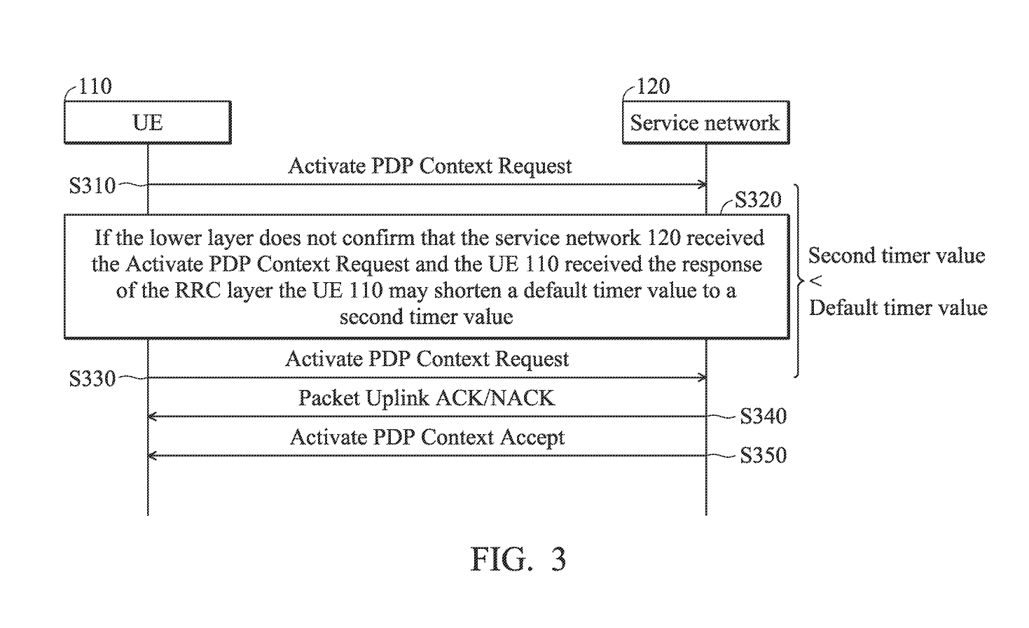

FIG. 3 is a message sequence chart illustrating PDP context activation procedure in a mobile communications system according to another embodiment of the invention. Firstly, the UE 110 transmits an Activate PDP Context Request to the service network 120 in the SM layer (step S310). Then, if the lower layer does not confirm that the service network 120 received the Activate PDP Context Request and the UE 110 received the response of the RRC layer, the UE 110 may shorten a default timer value to a second timer value, wherein the default timer value is used to determine whether UE 110 needs to retransmit the Activate PDP Context Request to the service network again (step S320) Then, the UE 110 may retransmit the Activate PDP Context Request again after the second timer value (step S330). In this embodiment, the UE 110 has received the response of the Radio Resource Control (RRC) layer so that the UE 110 may know that the service network 120 cannot respond to the Activate PDP Context Request. Therefore, the UE 110 may wait the second timer value and then retransmit the Activate PDP Context Request again. When the service network 120 transmits the Packet Uplink ACK/NACK to the UE 110 through the lower layer (step S340) and the service network 120 transmits the Activate PDP Context Accept to the UE 110 (step S350), the PDP Context has been activated. In this embodiment, the second timer is activated according to the information of the lower layer and the RRC layer.

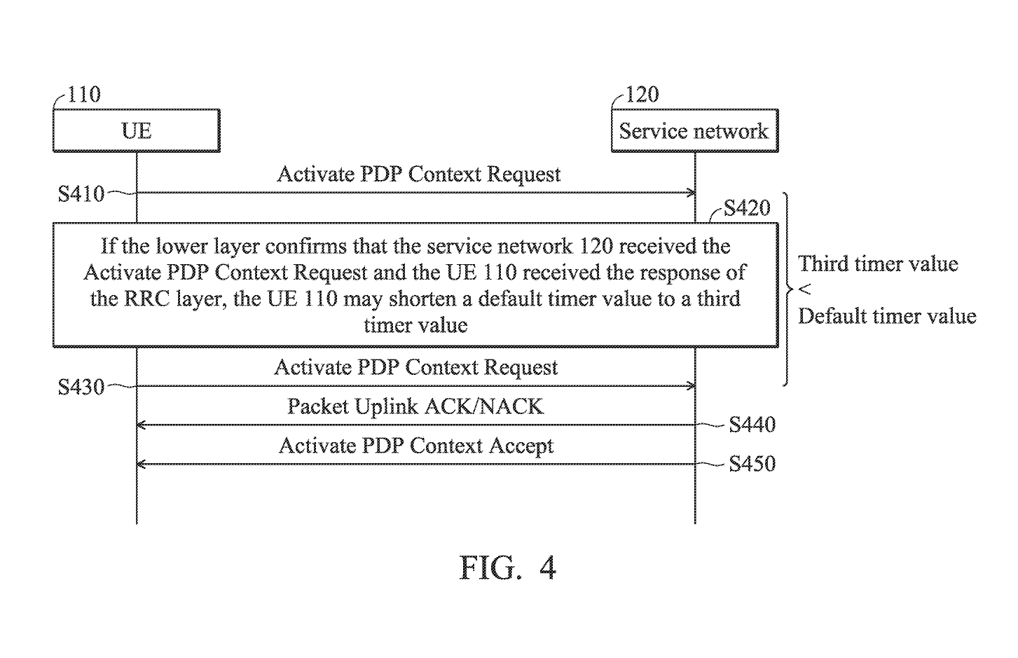

FIG. 4 is a message sequence chart illustrating PDP context activation procedure in a mobile communications system according to still another embodiment of the invention. Firstly, the UE 110 transmits an Activate PDP Context Request to the service network 120 in the SM layer (step S410). Then, if the lower layer confirms that the service network 120 received the Activate PDP Context Request and the UE 110 received the response of the RRC layer, the UE 110 may shorten a default timer value to a third timer value, wherein the default timer value is used to determine whether the UE 110 needs to retransmit the Activate PDP Context Request to the service network again (step S420). In this embodiment, the UE 110 has received the response of the Radio Resource Control (RRC) layer so that the UE 110 may know that the service network 120 cannot respond to the Activate PDP Context Request. Therefore, the UE 110 may wait the third timer value and then retransmit the Activate PDP Context Request again. Although, the lower layer has confirmed that the service network 120 received the Activate PDP Context Request, the UE 110 still needs to retransmit the Activate PDP Context Request to the service network 120 because the RRC connection between the UE 110 and the service network 120 has been released by the service network 120 and the service network 120 cannot respond to the Activate PDP Context Request. Then, the UE 110 may retransmit the Activate PDP Context Request again after the third timer value (step S430). When the service network 120 transmits the Packet Uplink ACK/NACK to the UE 110 through the lower layer (step S440) and the service network 120 transmits the Activate PDP Context Accept to the UE 110 (step S450), the PDP Context has been activated. In this embodiment, the third timer is activated after the UE 110 received the response of the RRC layer.

In some embodiments, if the lower layer confirms that the service network 120 received the Activate PDP Context Request and the UE 110 has not received the response of the RRC layer, the UE 110 may preserve the default timer value. Because in this situation, the service network 120 can receive the Activate PDP Context Request and respond to the Activate PDP Context Request normally, the UE 110 doesn't retransmit the Activate PDP Context Request to the service network 120. Therefore, the UE 110 does not need to shorten the default timer value.

In the above embodiments, a default timer may mean a T3380 timer with a 30-second default timer value. When the UE 110 transmits the Activate PDP Context Request to the service network 120 and there is no response from the service network 120 (according to the information of the lower layer and the RRC layer), the timer may be activated and the UE 110 may retransmit the Activate PDP Context Request to the service network 120 again after the default timer value ends. However the original default timer value is too long. Therefore, when the UE 110 needs to retransmit the Activate PDP Context Request, the UE 110 may shorten the default timer value to a smaller timer value, such as 5-8 seconds. The first timer value, second timer value and third timer value are only for illustrating the embodiments, they may be set to the same timer values or different timer values and the invention is not limited thereto.

Note that, in 2G communications systems such as General Packet Radio Service (GPRS) there is no RRC layer. Therefore, in the embodiments, the UE 110 only needs to be concerned with the response of the lower layer for determining whether to shorten the default timer value in the 2G communications system.

In some embodiments, a Transaction ID (TI) and/or a NSAPI may be changed if the default timer value is shortened. In the 3GPP standard, a T3380 timer is with a 30-second default timer value, it means that the service network 120 may respond to the Activate PDP Context Request from the UE 110 during 30-second default timer value. The UE 110 may retransmit the Activate PDP Context Request to the service network 120 again after the default timer value ends. However, when the default timer value is shortened, the UE110 may receive the Activate PDP Context Accept corresponding to the first Activate PDP Context Request after the Activate PDP Context Request retransmitted again. The side effect may occur because the PDP Context between the UE 110 and the service network 120 is not synchronized (e.g. IP of the PDP Context is different). Therefore, some solutions for the side effect are provided as follow.

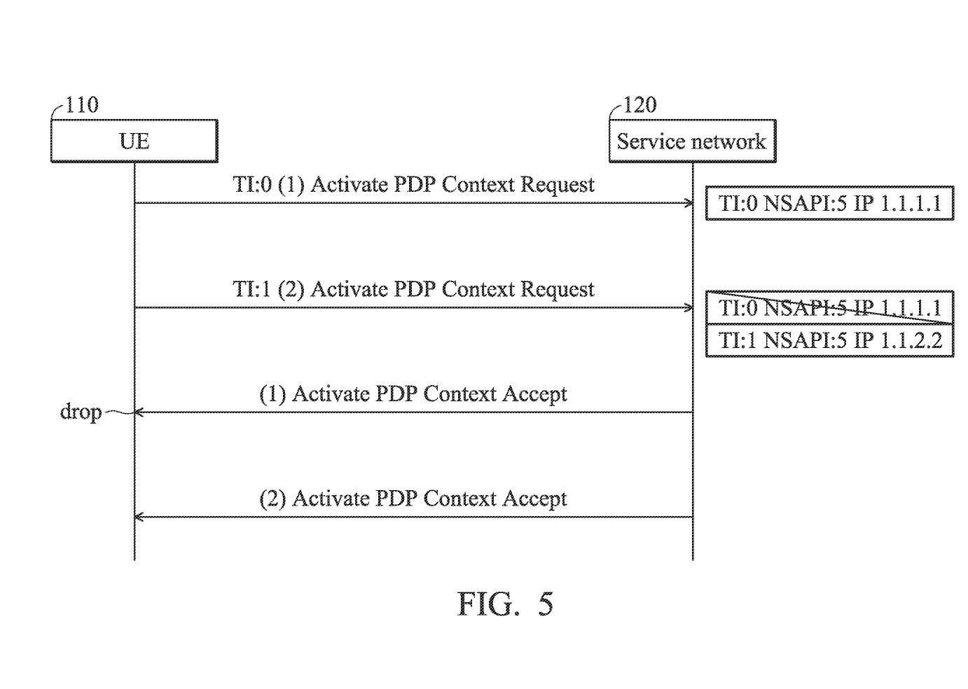

FIG. 5 is a message sequence chart illustrating one solution for the side effect in a mobile communications system according to an embodiment of the invention. In FIG. 5, the Transaction ID (TI) of the first transmitted Activate PDP Context Request is set to 0, and the TI of the second transmitted Activate PDP Context Request (retransmitted) is set to 1. When the UE 110 receives the Activate PDP Context Accept corresponding to the first transmitted Activate PDP Context Request and the Activate PDP Context Accept corresponding to the second transmitted Activate PDP Context Request from the service network 120, the UE 110 may drop the Activate PDP Context Accept corresponding to the first transmitted Activate PDP Context Request according to the TI value.

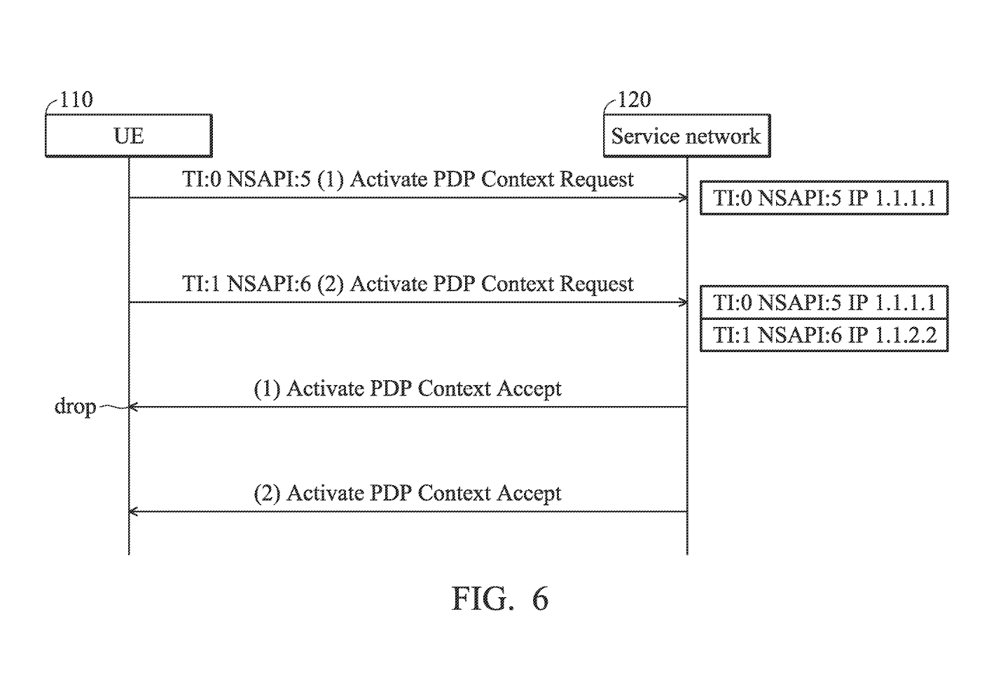

FIG. 6 is a message sequence chart illustrating another solution for the side effect in a mobile communications system according to an embodiment of the invention. In FIG. 6, the TI and the Network Service Access Point Identifier (NSAPI) of the first transmitted Activate PDP Context Request are set to 0 and 5 respectively. The TI and NSAPI of the second transmitted Activate PDP Context Request are set to 1 and 6 respectively. When the UE 110 receives the Activate PDP Context Accept corresponding to the first transmitted Activate PDP Context Request and the Activate PDP Context Accept corresponding to the second transmitted Activate PDP Context Request from the service network 120, the UE 110 may drop the Activate PDP Context Accept corresponding to the first transmitted Activate PDP Context Request according to the TI value and the NSAPI value.

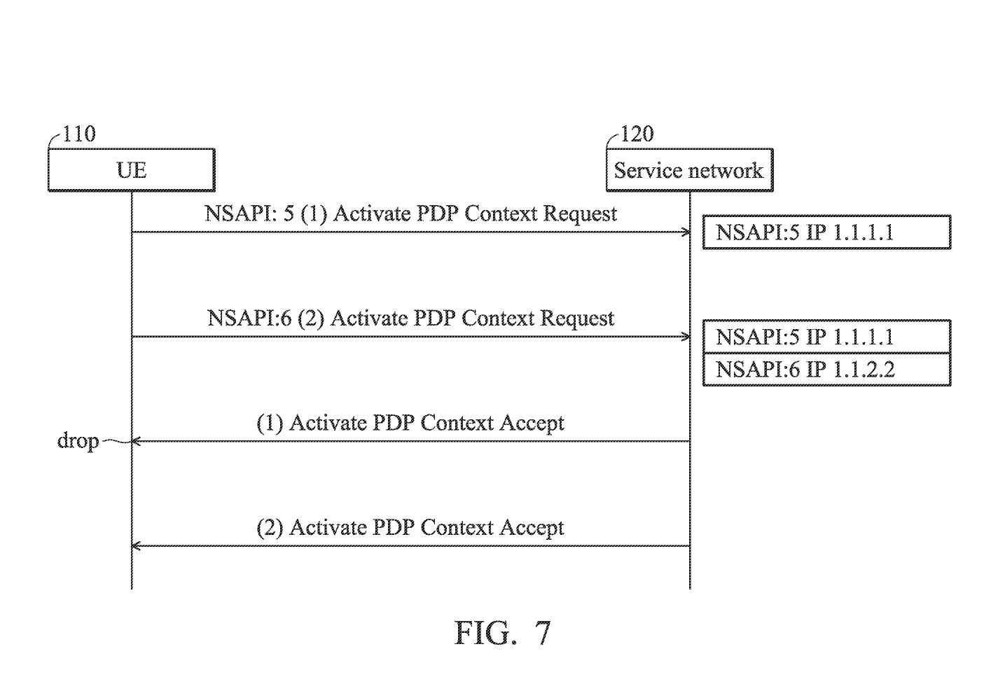

FIG. 7 is a message sequence chart illustrating still another solution for the side effect in a mobile communications system according to an embodiment of the invention. In FIG. 7, the NSAPI of the first transmitted Activate PDP Context Request is set to 5. The NSAPI of the second transmitted Activate PDP Context Request is set to 6. When the UE 110 receives the Activate PDP Context Accept corresponding to the first transmitted Activate PDP Context Request and the Activate PDP Context Accept corresponding to the second transmitted Activate PDP Context Request from the service network 120, the UE 110 may drop the Activate PDP Context Accept corresponding to the first transmitted Activate PDP Context Request according to the NSAPI value.

At the PDP context activation procedures, the UE 110 may request PDP context with a TI and a NSAPI. At the service network 120, if the NSAPI from the Activate PDP Context Request matches the existing one, the service network 120 should deactivate the original one locally and proceed to the new request, then send a PDP Context Accept. If the service network 120 sends the PDP Context Accept to the UE 110 after the UE 110 retransmits the next Activate PDP Context Request, the side effect may occur. For example, in FIG. 5, if the TI and NSAPI of the retransmitted Activate PDP Context Request are not changed (the TIs and NSAPIs of the first and second Activate PDP Context Request are the same), the UE 110 may determine the two Activate PDP Context Accepts from the service network 120 are the same, and drop the Activate PDP Context Accept corresponding to the second Activate PDP Context Request. Therefore, in the solution method of the embodiments, the side effect may be avoided after changing the TI and/or NSAPI.

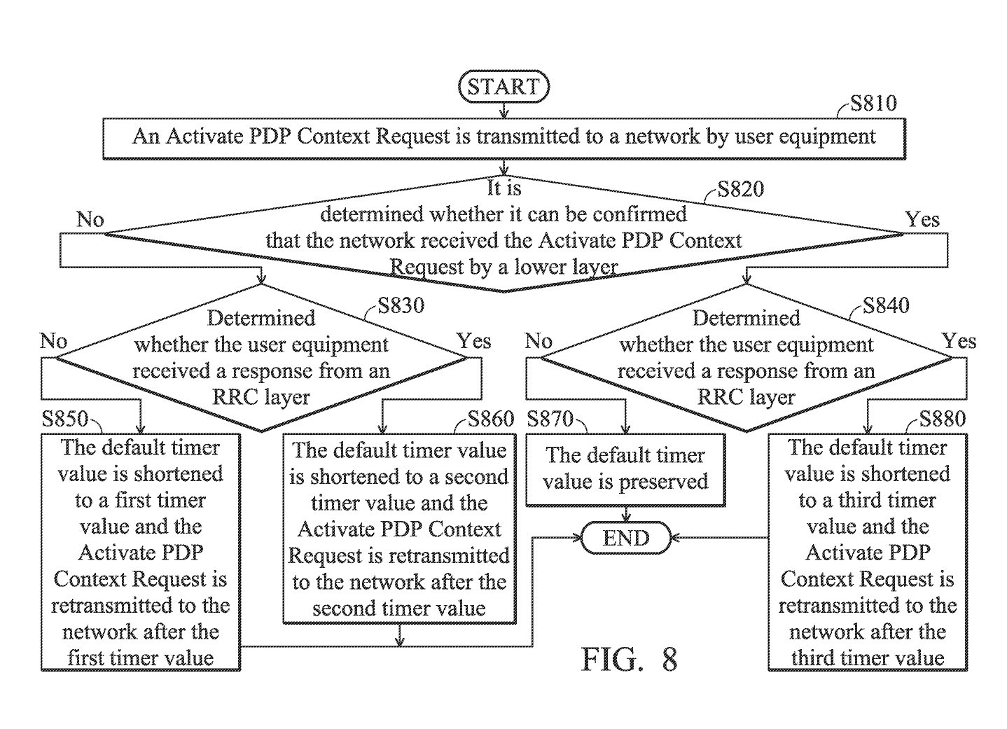

FIG. 8 is a flow chart illustrating the method for accelerating connection establishment in a mobile communications system according to an embodiment of the invention. Firstly, in step S810, an Activate PDP Context Request is transmitted to a network by user equipment. Then, in step S820, it is determined whether user equipment can be confirmed that the network received the Activate PDP Context Request by an lower layer. In step S830, if the lower layer does not confirm that the network received the Activate PDP Context Request, it is further determined whether the user equipment received a response from an RRC layer, wherein the response of the RRC layer indicates that the network cannot respond to the Activate PDP Context Request. In step S840, if the lower layer confirms that the network received the Activate PDP Context Request, it is further determined whether the user equipment received a response from an RRC layer, wherein the response of the RRC layer indicates that the network cannot respond to the Activate PDP Context Request.

If the lower layer does not confirm that the network received the Activate PDP Context Request and the user equipment has not received the response from the RRC layer, the default timer value is shortened to a first timer value and the Activate PDP Context Request is retransmitted to the network after the first timer value (step S850). If the lower layer does not confirm that the network received the Activate PDP Context Request and the user equipment received the response of the RRC layer, the default timer value is shortened to a second timer value and the Activate PDP Context Request is retransmitted to the network after the second timer value (step S860). If the lower layer confirms that the network received the Activate PDP Context Request and the user equipment has not received the response of the RRC layer, the default timer value is preserved (step S870). If the lower layer confirms that the network received the Activate PDP Context Request and the user equipment received the response of the RRC layer, the default timer value is shortened to a third timer value and the Activate PDP Context Request is retransmitted to the network after the third timer value (step S880).

In this embodiment, a Transaction ID (TI) may be changed if the default timer value is shortened by the user equipment. In this embodiment, a Transaction ID (TI) and a NASPI may be changed if the default timer value is shortened by the user equipment. In this embodiment, user equipment only needs to determine the response of the lower layer if it is in the 2G communications system.

In the method, the user equipment can reduce the waiting time of default timer value and retransmit the next Activate PDP Context Request again earlier according to the lower layer and the RRC layer information. In addition, in the method, the side effect can be avoided. Therefore, the method can avoid test cases failing and bad feelings on the part of the user.

The steps of the method described in connection with the aspects disclosed herein may be embodied directly in hardware, in a software module executed by a processor, or in a combination of the two. A software module (e.g., one including executable instructions and related data) and other data may reside in data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects, a computer program product may comprise packaging materials.

The above paragraphs describe many aspects. Obviously, the teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for accelerating connection establishment in a mobile communications system, comprising:
transmitting, by a user equipment, an Activate PDP Context Request to a network;
determining whether the user equipment can be confirmed that the network received the Activate PDP Context Request by an lower layer;
shortening a default timer value and retransmitting the Activate PDP Context Request to the network after the shortened default value if the lower layer does not confirm that the network received the Activate PDP Context Request; and
preserving the default timer value if the lower layer confirms that the network received the Activate PDP Context Request.

2. The method of claim 1, further comprising:
determining whether the user equipment received a response from an RRC layer after determining whether it can be confirmed that the network received the Activate PDP Context Request from the lower layer, wherein the response of the RRC layer indicates that the network cannot respond to the Activate PDP Context Request.

3. The method of claim 2, wherein if the lower layer does not confirm that the network received the Activate PDP Context Request and the user equipment has not received the response of the RRC layer, the default timer value is shortened to a first timer value and the Activate PDP Context Request is retransmitted to the network after the first timer value.

4. The method of claim 3, wherein if the lower layer does not confirm that the network received the Activate PDP Context Request and the user equipment received the response of the RRC layer, the default timer value is shortened to a second timer value and the Activate PDP Context Request is retransmitted to the network after the second timer value.

5. The method of claim 4, wherein if the lower layer confirms that the network received the Activate PDP Context Request and the user equipment did not receive the response of the RRC, the default timer value is preserved.

6. The method of claim 5, wherein if the lower layer confirms that the network received the Activate PDP Context Request and the user equipment received the response of the RRC layer, the default timer value is shortened to a third timer value and the Activate PDP Context Request is retransmitted to the network after the third timer value.

7. The method of claim 2, further comprising:
changing a Transaction ID (TI) and/or a Network Service Access Point Identifier (NSAPI) if the default timer value is shortened.

8. An apparatus for accelerating connection establishment in a mobile communications system, operating as a user equipment (UE), comprising:
a transceiver, configured to transmit an Activate PDP Context Request to a network; and
a processing unit, configured to determine whether it can be confirmed that the network received the Activate PDP Context Request by a lower layer,
wherein if the lower layer does not confirm that the network received the Activate PDP Context Request, a default timer value is shortened by the processing unit and the Activate PDP Context Request is retransmitted to the network by the transceiver after the shortened default value; and
wherein if the lower layer confirms that the network received the Activate PDP Context Request, the default timer value is preserved.

9. The apparatus of claim 8, wherein the processing unit further determines whether the user equipment received a response from an RRC layer after determining whether it can be confirmed that the network received the Activate PDP Context Request from the lower layer, wherein the response of the RRC layer indicates that the network cannot respond to the Activate PDP Context Request.

10. The apparatus of claim 9, wherein if the lower layer does not confirm that the network received the Activate PDP Context Request and the user equipment has not received the response of the RRC layer, the default timer value is shortened to a first timer value and the Activate PDP Context Request is retransmitted to the network after the first timer value.

11. The apparatus of claim 10, wherein if the lower layer does not confirm that the network received the Activate PDP Context Request and the user equipment received the response of the RRC layer, the default timer value is shortened to a second timer value and the Activate PDP Context Request is retransmitted to the network after the second timer value.

12. The apparatus of claim 11, wherein if the lower layer confirms that the network received the Activate PDP Context Request and the user equipment has not received the response of the RRC layer, the default timer value is preserved.

13. The apparatus of claim 12, wherein if the lower layer confirms that the network received the Activate PDP Context Request and the user equipment received the response of the RRC layer, the default timer value is shortened to a third timer value and the Activate PDP Context Request is retransmitted to the network after the third timer value.

14. The apparatus of claim 9, wherein a Transaction ID (TI) and/or a Network Service Access Point Identifier (NSAPI) are changed by the processing unit if the default timer value is shortened.
